(19) United States
(12) Patent Application Publication
(10) Pub. No.: US 2003/0126483 A1
(43) Pub. Date: Jul. 3, 2003

(54) Computer starter and starting method for utilizing smart card interface

(75) Inventors: Chao-Hsiang Huang, Hsinchu (TW); Yi-Chuan Lu, Hsinchu (TW); Che-Min Liao, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Winbond Electronics Corp., Hsinchu (TW)

(21) Appl. No.: 10/138,105

(22) Filed: May 3, 2002

(30) Foreign Application Priority Data
Dec. 27, 2001 (TW) 90132606

(51) Int. Cl. G06F 1/26

(52) U.S. Cl. 713/310

(57) ABSTRACT

A starter for starting a computer system is provided. The starter includes: an IC card interface for generating an enable signal when an IC card is inserted; a register set for storing a command provided to the IC card and a computer secure check signal and detecting whether a user secure check signal matches the computer secure check signal or not; a state machine for reading the user secure check signal from the IC card interface to proceed a secure check process, generating a verification signal when the user secure check signal matches the computer secure check signal, and generating a reset signal to reset the IC card and proceed the computer secure check process again when the user secure check signal matches the computer secure check signal; and a power control circuit for generating a Power On signal to a power supply of the computer system in response to the check signal and starting the computer system.

### FIELD OF THE INVENTION

This invention relates to a computer starter and starting method capable of turning on the computer system upon insertion of a smart card, and more particularly to a computer starter utilizing a state machine, a command register and a data register instead of a microprocessor and a non-volatile memory, respectively.

### BACKGROUND OF THE INVENTION

Please refer to FIG. 1. FIG. 1 shows the block diagram for the computer starter of the ATX computer system in the prior art. It was also taught by the U.S. Pat. No. 6,128,744. A computer starter and starting method for the ATX computer system provided in U.S. Pat. No. 6,128,744 includes a power supply 10, a smart card interface 12, a clock generator 14, a micro-controller 16, a non-volatile memory 18, and a power control circuit 20. In this model, the computer starter utilizes the 5V standby voltage when the AXT computer system is turned off as a voltage source of the computer starter. In this embodiment, the smart card interface 12 can be a card reader. When the smart card is inserted into a smart card interface 12, a PRESENT signal is activated to generate an enable signal En to inform the computer and other peripherals. The clock generator 14 is driven by the enable signal En to generate a reference clock CLKS, and the micro-controller 16 is driven by the reference clock CLKS to read out the user identification signal stored in the smart card. The user identification includes at least an identity and a corresponding password for a user. In the non-volatile memory 18 is stored a plural of computer identification signals. The non-volatile memory 18 can be memory or an electrically erasable programmable read-only memory. When micro-controller 16 is driven by the reference clock CLK_{S} to output a reset signal (RST), a power voltage (V_{DDCARD}), a clock signal (CLK_{CARD}), and I/O signals through the smart card 12. These signals are used to reset the smart card, read the user identification signal stored in the smart card, and generate a verification signal (V_{ON}) to the power control circuit 20 when the computer identification signal stored in the non-volatile memory matches the user identification signal stored in the smart card. The power control circuit 20 will output a start signal (PS_ON#) to the AXT power supply of the AXT computer system in response to the received verification signal (V_{ON}) so as to turn on the AXT computer system.

In the computer starter as shown in FIG. 1, in spite of the situation described as mentioned above, the micro-controller 16 generally needs greater chip volume, and the cost of the non-volatile memory 18 is more expensive, too. Consequently, it is necessary to provide a computer starter which doesn't use a complicated control circuit and additional device to set memory for storing the user authorization data.

### SUMMARY OF THE INVENTION

It is an object of the present invention to provide a computer starter and starting method for utilizing a smart card interface.

It is another object of the present invention to provide a method and device to detect the insertion of a smart card, and then turn on the computer system to execute the secure check process to avoid the unauthorized user who tries to turn on the computer system.

The present invention provides a starter for starting a computer system including an IC card interface for generating an enable signal when an IC card is inserted, a register set for storing a command provided to the IC card and a computer secure check signal and detecting whether a user secure check signal matches the computer secure check signal or not, a state machine for reading the user secure check signal from the IC card interface to proceed a secure check process, generating a verification signal when the user secure check signal matches the computer secure check signal, and generating a reset signal to reset the IC card and proceed the computer secure check process again when the user secure check signal doesn't match the computer secure check signal, and a power control circuit for generating a Power On signal to a power supply of the computer system in response to the check signal and starting the computer system.

Preferably, the IC card interface is a card reader.

Preferably, the IC card interface is built in a super input/output unit of the computer system.

Preferably, the computer check signal is accessed by a central processing unit of the computer system.

Preferably, the computer check signal at least includes a user data and a corresponding code.

Preferably, the power control circuit is controlled by the central processing unit of the computer system.

Preferably, the starter further includes a clock generator for producing a reference clock in response to the enable signal to drive the state machine.

In accordance with another aspect of the present invention, a method for starting a computer system, wherein the computer system includes a register, a state machine, and a power control circuit, including steps of generating an enable signal when an IC card is inserted into the computer system; storing a command and a computer secure check signal of the IC card in the register set; employing the state machine for reading a user secure check signal from the IC card to proceed a secure check process, generating a check signal when the user secure check signal matches the computer secure check signal, and generating a reset signal to reset the IC card and proceed the secure check process again when the user secure check signal doesn't match the computer secure check signal; and generating a Power On signal in response to the check signal and starting the computer system by the power control circuit.

Preferably, the enable signal is generated upon inserting an IC card into the IC card interface.

Preferably, the IC card interface is built in a super input/output unit of the computer system.

Preferably, the method further includes a step of generating a reference clock in response to the enable signal.

Preferably, the computer check signal at least includes a user data and a corresponding code.

Preferably, the power control is controlled by a central processing unit of the computer system.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates a circuit block diagram of the computer starter for the ATX computer in the prior art; and

FIG. 2 illustrates a block diagram of the computer starter according to a preferred embodiment of the present invention.

### DETAILED DESCRIPTION OF THE PREFERRED EMBODIMENT

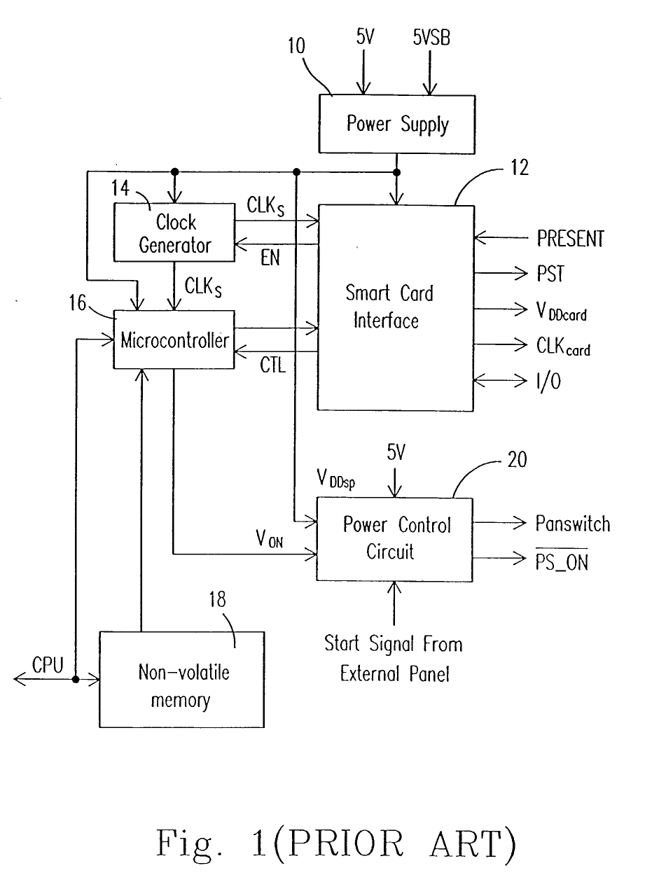

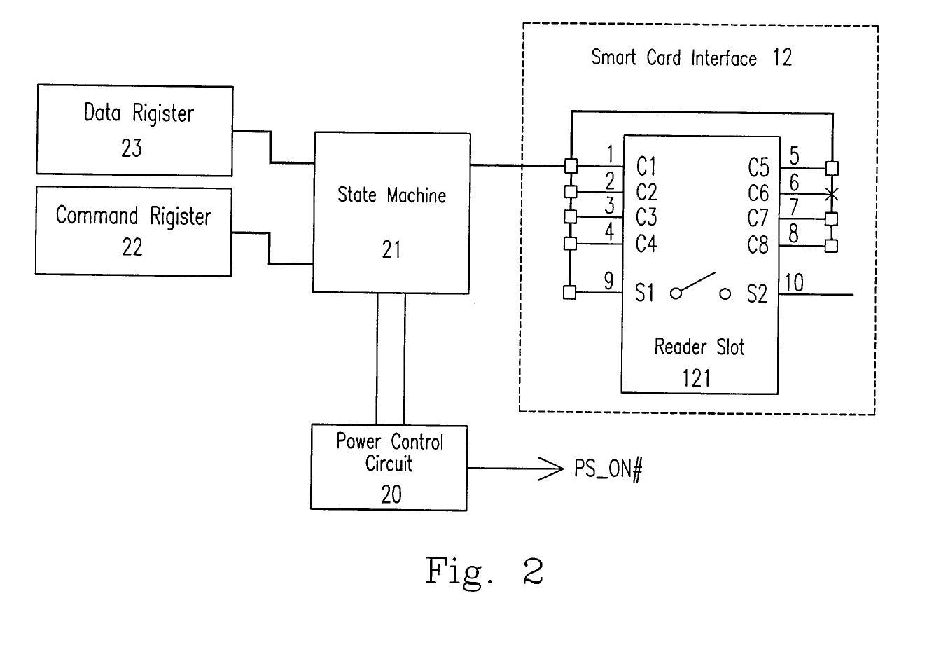

Please refer to FIG. 2. FIG. 2 shows a computer starter according to a preferred embodiment of the present invention. The computer starter includes a state machine 21, a register set composed of a command register 22 and a data register 23, a smart card interface 12, and a power control circuit 20. The smart card interface 12 (generally a card reader) is built in a super I/O of the computer system. In FIG. 2, the function of the power control circuit 20 and the smart card interface 12 are the same with the prior art. The computer starter according to the present application further includes a power supply and a clock generator whose configurations and operation methods are the same with the power supply 10 and the clock generator 14 of the computer starter as shown in FIG. 1, respectively. Thus all these are not shown in the preferred embodiment according to the present invention. However, the one who is skilled in the art still can base on the computer starter in the present application to coordinate the hardware design of the computer system so as to accomplish the operation of the computer system starting.

As shown in FIG. 2, both the state machine 21 and the smart card interface 12 use the standby voltage (5V) provided as a voltage source. The register set uses a DC voltage provided by a battery as a main power. The smart card interface 12 is used for detecting the existence of the smart card. When the smart card is inserted into the reader slot 121 of the smart card interface 12, The smart card interface 12 generates an enable signal to the clock generator. Then, the clock generator will output a reference clock signal to the state machine 21 in response to the enable signal. The state machine 21 which includes a secure control machine and a secure check logical kernel circuit for handling all secure check processes of the smart card is driven by the reference clock signal. The command register 22 is used for storing the commands of the smart card and informing the smart card to execute these commands. The data register 23 is used for storing the computer secure check data, for example, an identity and the corresponding password of an authorized user. The data register 23 can also store a user secure check data which is the response data of the smart card (e.g., the identify and password inputted by the user). And then the data register 23 will match the user secure check data with the computer secure check data so as to execute the secure check process. If the result of the secure check process is passed, the state machine 21 will output a verification signal to the power control circuit 20 which is controlled by the Central Processing Unit (CPU). The power control circuit 20 will output a Power On signal (PS_ON#) to control the power supply of the computer system in response to the verification signal. If the result of the secure check process is fail, the state machine 21 will output a reset signal to reset the smart card through the smart card interface 12 . However, the secure check process will proceed again.

Before the user uses the smart card to turn on the computer system, the user identification must be registered in the application programor in the BIOS of the computer system. When the computer system is turned off, the user can insert the smart card into the smart card slot 121 to power on the computer system. Once the smart card is detected by the smart card interface 12, the smart card interface 12 will generate an enable signal to enable the clock generator to output a reference clock signal to the state machine 21. The state machine 21 is driven by the reference clock signal and transmits the relative secure data and the command to the smart card through the smart card interface 12. The smart card will check all the secure data and transmit the user check data to the data register 23. The state machine 21 will determine whether the check data inputted by the user matches the computer check data or not. If the result of the secure check process is proceed, the state machine 21 will generate a verification signal to drive the power control circuit 20 to turn on the computer system. If the answer is fail, the state machine 21 will reset the smart card and keep the computer in the Power Off state.

The present invention provides an improved computer starter according to the prior art as shown in FIG. 1. The micro-controller is replaced by the state machine, and the non-volatile memory is replaced by the register set. The register set is used for storing the command and the computer check data and detecting whether the user check data inputted by the user matches the computer check data or not. The state machine handles all the secure check processes and sequentially outputs the data stored in the register set. When the register set detects that the user check data inputted by the user matches the computer check data, the state machine will drive the power control circuit to turn on the computer system. Because the micro-controller is replaced by the state machine, the internal circuit will be more simplified and the volume of the chip can be reduced, too. Simultaneously, the usage of replacing the memory pattern by the internal register set to store the command and the data can also reduce the manufacturing cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A starter for starting a computer system, comprising:
an IC card interface for generating an enable signal when an IC card is inserted;
a register set for storing a command provided to said IC card and a computer secure check signal and detecting whether a user secure check signal matches said computer secure check signal or not;
a state machine for reading said user secure check signal from said IC card interface to proceed a secure check process, generating a verification signal when said user secure check signal matches said computer secure check signal, and generating a reset signal to reset said IC card and proceed said computer secure check process again when said user secure check signal doesn't match said computer secure check signal; and
a power control circuit for generating a Power On signal to a power supply of said computer system in response to said check signal and starting said computer system.

2. A starter according to claim 1 wherein said IC card interface is a card reader.

3. A starter according to claim 1 wherein said IC card interface is built in a super input/output unit of said computer system.

4. A starter according to claim 1 wherein said computer check signal is accessed by a central processing unit of said computer system.

5. A starter according to claim 1 wherein said computer check signal at least includes a user data and a corresponding code.

6. A starter according to claim 1 wherein said power control circuit is controlled by said central processing unit of said computer system.

7. A starter according to claim 1 wherein said starter further comprises a clock generator for producing a reference clock in response to said enable signal to drive said state machine.

8. A method for starting a computer system, wherein said computer system comprises a register, a state machine, and a power control circuit, comprising steps of:
(a) generating an enable signal when an IC card is inserted into said computer system;
(b) storing a command and a computer secure check signal of said IC card in said register set;
(c) employing said state machine for reading a user secure check signal from said IC card to proceed a secure check process, generating a check signal when said user secure check signal matches to said computer secure check signal, and generating a reset signal to reset said IC card and proceed said secure check process again when said user secure check signal doesn't match said computer secure check signal; and
(d) generating a Power On signal in response to said check signal and starting said computer system by said power control circuit.

9. A method according to claim 8 wherein said enable signal is generated upon inserting an IC card into said IC card interface.

10. A method according to claim 8 wherein said IC card interface is built in a super input/output unit of said computer system.

11. A method according to claim 8 wherein said step (a) further comprises a step of generating a reference clock in response to said enable signal.

12. A method according to claim 8 wherein said computer check signal at least includes a user data and a corresponding code.

13. A method according to claim 8 wherein said power control is controlled by a central processing unit of said computer system.
